(19) United States
(12) Patent Application Publication
(10) Pub. No.: US 2013/0258341 A1
(43) Pub. Date: Oct. 3, 2013

(54) Sample Accessory for Handheld Spectrometers

(71) Applicants: David R. DAY, Boxford, MA (US); Daniel Robert Klevisha, Merrimack, NH (US)

(72) Inventors: David R. DAY, Boxford, MA (US); Daniel Robert Klevisha, Merrimack, NH (US)

(21) Appl. No.: 13/431,676

(22) Filed: Mar. 27, 2012

(51) Int. Cl. G01J 3/42

(52) U.S. Cl. 356/402

(57) ABSTRACT

A sampling accessory coupled to a hand-held reflectance spectrometer provides expanded sampling area which in turn provides better signal averaging from agricultural products which are often inhomogeneous. The sampling accessory includes a sample site repositioning means and a “sample cup” having a base that is transparent to near IR wavelengths.

The hand-held reflectance spectrometer includes a shutter responsive to control signals from the control circuitry. When the shutter is closed, a reference measurement may be made. When the shutter is open, a sample measurement is taken.

Sample repositioning and data acquisition within the cup may be performed by several means. Fresh sample regions may be exposed through either manual or motor driven sample cup rotation. Alternatively, the sample may be vibrated to induce fresh sample exposure at the window. A further embodiment includes illumination and/or detection paths that may be altered through electrically driven steering optics.

### BACKGROUND

Near infra-red (NIR) spectroscopy is used for food, pharmaceutical, petroleum, and agricultural industries for identification and quantification of chemical compounds. Until now, the technique has been limited to traditional lab based instruments due to the required stability, accuracy and data processing power. In recent years, handheld microelectromechanical (MEMS)-based NIR Hadamard transform spectrometers have been introduced that exhibit lab instrument accuracy and precision. With the advent of this type of instrumentation combined with the sampling technology described by this patent, the restriction of such measurements to a lab only environment has been eliminated. Food, feed and agricultural sample analysis can now be performed successfully in the field with such portable instrumentation.

For food, feed, and agricultural products, it is practically impossible to analyze the entire batch. A representative sample of the total product is taken, from which the appropriate analysis can be made. For samples that will be analyzed in the lab environment, a representative sample is obtained by taking several primary samples. Once they have been gathered and mixed together in a clean receptacle, they constitute a global sample on which the necessary test will be made. Analysis often occurs by placing the material in a sample cup designed to be compatible with the benchtop laboratory instrumentation.

### SUMMARY

A sampling accessory coupled to a hand-held reflectance Hadamard transform spectrometer provides expanded sampling area which in turn provides better signal averaging from agricultural products which are often inhomogeneous.

The sampling accessory includes a sample site repositioning means and a “sample cup” having a base that is transparent to near IR wavelengths. The hand-held reflectance spectrometer includes a shutter responsive to control signals from the control circuitry.

When the shutter is dosed, a baseline measurement, e.g. reference measurement, may be made. When the shutter is open, a sample measurement is taken.

Sample repositioning and data acquisition within the cup may be performed by several means. Fresh sample regions may be exposed through either manual or motor driven sample cup movement. Alternatively, the sample may be vibrated to induce fresh sample exposure at the window. A further embodiment includes illumination and/or detection paths that may be altered through electrically driven steering optics.

### BRIEF DESCRIPTION OF THE DRAWINGS

FIG. 1 illustrates an analyzer including a hand-held instrument, e.g. handheld reflectance spectrometer.

FIG. 2 illustrates the sample accessory 14 shown in FIG. 1.

FIG. 3 illustrates an embodiment using electrically driven beam steering optics.

FIG. 4 illustrates the sample cup and the axis of rotation.

FIG. 5 illustrates a process flowchart according to the invention.

### DETAILED DESCRIPTION

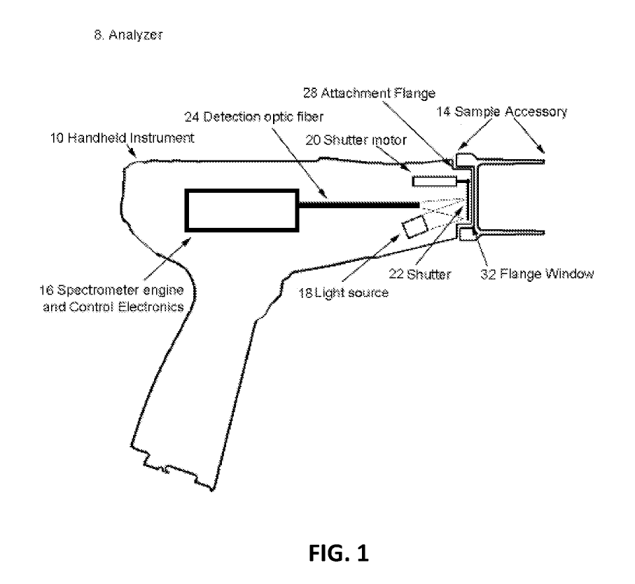

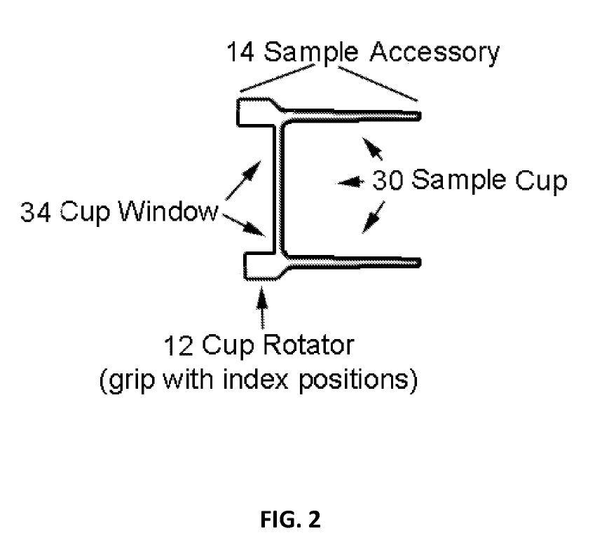

FIG. 1 illustrates an analyzer 8 including a hand-held instrument 10, e.g. reflectance spectrometer, and a sample accessory 14 that includes an optional sample site repositioner (not shown) and a sample cup 30. FIG. 2 further illustrates the sample accessory shown in FIG. 1. The hand-held instrument 10 includes a spectrometer engine and control circuitry 16, a light source 18, a shutter motor 20, a shutter 22, and detection optics 24, e.g. an optic fiber leading to the spectrometer engine.

The sample accessory 14 consists of a sample site repositioner, e.g. cup rotator 12, and a sample cup 30. The attachment flange 28 houses the shutter 22 and the flange window 32. The attachment flange 28 is contoured to receive the sample accessory 14 with positive “snap in” for reproducible positioning. The shutter 22 interposes the flange window 32 and the detection optics 24 that lead to the spectrometer engine 16. The shutter 22 is responsive to control signals provided by the control circuitry 16 through activation of a mechanically coupled shutter motor 20. In this illustrative example, the shutter 22 has a diffuse gold surface designed to reflect light at all angles regardless of the incidence angle, e.g. Lambertian reflectance. Other suitable materials include but are not limited to diffuse gold, PTFE materials such as SpectraIon and Fluorilon, and aluminum. Other materials may also be used as long as the reflectance is stable with time, temperature, and humidity.

The hand-held instrument 10 may be a hand-held near IR Hadamard transform spectrometer such as that disclosed in by McAllister, et al. in U.S. Pat. No. 7,791,027, “Apparatus and Method Providing a Hand-Held Spectrometer,” assigned to Polychromix Corporation, a wholly owned subsidiary of Thermo Fisher Scientific. In this context, a “hand-held” spectrometer instrument weighs less than 10 kg, and more typically less than 5, 2, 1, or even less than 0.5 or 0.2 kg, and may have dimensions of less than 50 cm or 30 cm in each dimension, and one of the dimensions (the thickness) may even be less than 10 cm or 5 or 3 cm. A “hand-held” spectrometer will often be battery powered with the battery typically fitting within the foregoing dimensions and included in the foregoing weights, although a separate power supply could be provided and connected to the spectrometer.

To be a practical “hand-held” instrument, the IR spectrometer should meet generally accepted ergonomic standards for such tools. Eastman Kodak's publication [Eastman Kodak Co. 1983, Ergonomic Design for People at Work, Lifetime Learning Pub., Belmont, Calif.] describes requirements for hand-held tools generally and includes a recommended maximum weight of five pounds for hand-held tools. Further, the size/volume of the tool should be small enough so that the tool is not cumbersome and unwieldy. The above-recommended maximum weight may also limit the power capacity of the tool, and consequently, the amount of time that the tool can operate. That is, the weight of a power source generally increases as its power rating increases, and in particular, the weight of battery power sources becomes quite large relative to the overall weight of the tool when large amounts of power are required for the tool's operation. As a result, the power consumption of the tool should be controlled to allow the tool to be used over an extended period of time (e.g., hours) with a relatively lightweight power source, for example, a battery power source that is light enough to be employed in a hand-held tool.

In practice, to be hand held and portable, a spectrometer should contain its own light source. Light sources, however, consume a considerable amount of power. Thus, the power consumption of both the spectrometer electronics and the light source are important considerations when developing a hand held IR spectrometer.

The analyzer attachment flange 28 may be in direct contact with a sample. Alternatively, an optional sample accessory 14 is used to contain the sample. The base of the sample accessory 14 is a window 32 that is transparent to the light source 18. In this illustrative example, the window is transparent to near IR frequencies.

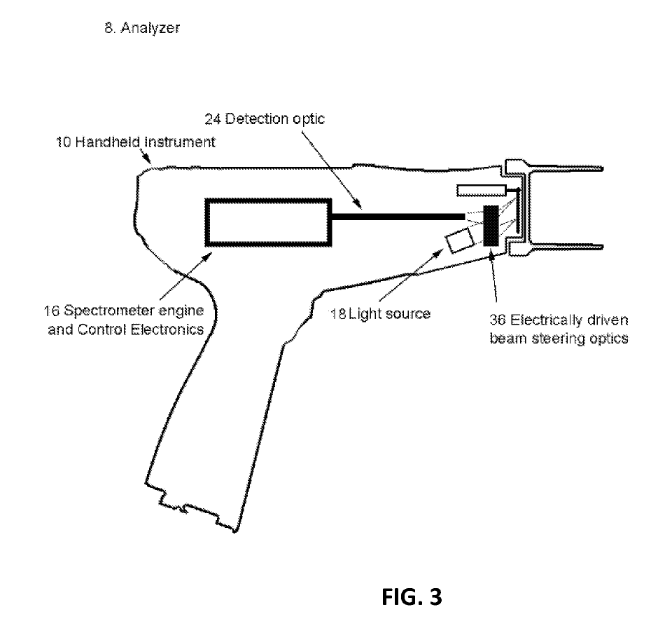

The sample site repositioning may be performed automatically or manually. Repositioning may be done by moving the sample, sample accessory, or beam steering optics (shown in FIG. 3). Alternatively, an agitation motion could be applied that may be lateral, vertical, or rotational. When required, a lid (not shown) may be attached to the sample cup to retain the sample. This provides for multiple measurements of a non-homogeneous sample, e.g. animal feed.

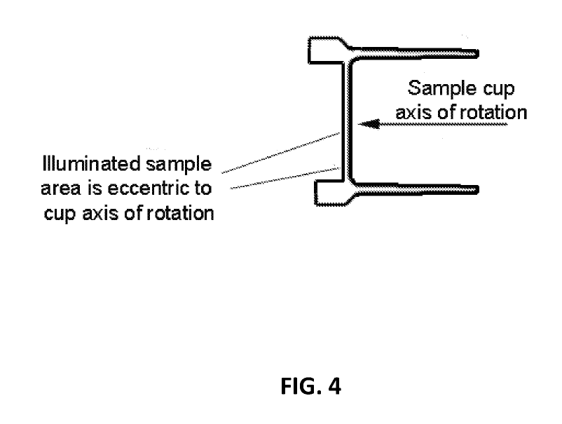

The sample accessory 14 may be integrated into the housing of the handheld instrument 10 or a detachable cup. The analyzer 8 may be in direct contact with the sample. Alternatively, the detachable sample cup 30 is used to contain the sample. FIG. 2 shows the sample cup 30 in more detail. The base of the sample cup 30 is a cup window 34 that is transparent to the excitation source. In this illustrative example, the cup window 34 is transparent to near IR wavelengths. A cup rotator 12 is positioned proximate the window 32. The sample cup's axis of rotation is not coincident with the center of an illuminated area permitting the plurality of different regions on the sample (as shown in FIG. 4). In this way, cup rotation results in an entirely new sample area to be illuminated. The cup rotator 12 includes at least two positions, each position accessing a unique section of sample. The positions may be indexed, e.g. defined rotation positions, or unspecified.

The sample site may also be repositioned on the sample by a beam steering mechanism. The mechanism may move the illumination source and detection optics, or it may redirect the illumination and detection path via optical deflection (mirrors or lenses).

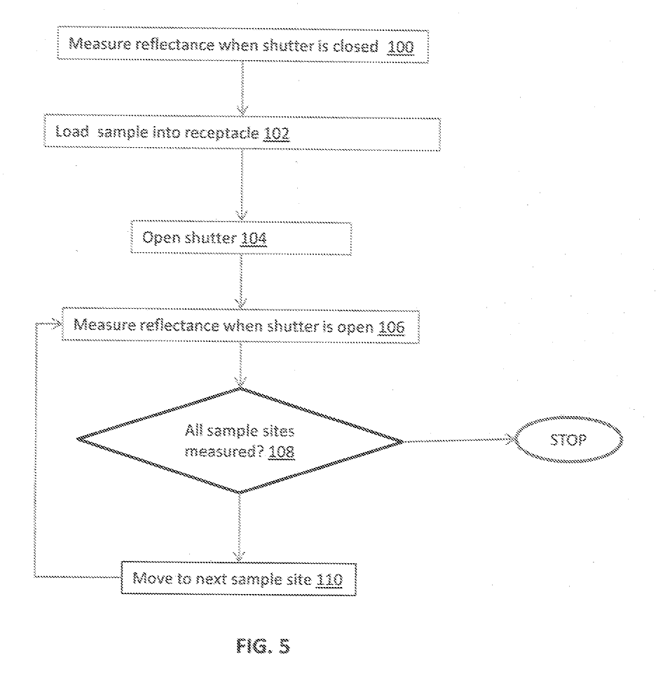

FIG. 5 illustrates a process flowchart according to the invention. In step 100, a reference measurement is made when the shutter is closed. In step 102, sample is loaded into the sample cup. In step 104, the shutter is opened. In step 106, a measurement is taken. In step 108, it is determined if new sample sites are available. If yes, in step 110, a new sample site is exposed. If no, stop.

I claim:

1. A hand-held analyzer comprising:
a hand-held spectrometer including,
a housing that has an optical port,
spectrometer engine and control circuitry positioned within the housing,
a light source, within the housing, transmitting a beam through the optical port, the beam impinging upon and reflecting from a sample, and
detection optics, coupled to the spectrometer engine, positioned within the housing, receiving the reflected beam; and
a sample site repositioner causing the beam to impinge on a plurality of different regions on the sample.

2. An analyzer, according to claim 1, further including a sample cup positioned proximate the optical port, having a base that is transmissive to the beam and the reflected beam.

3. An analyzer, according to claim 2, wherein the sample site repositioner moves the sample region with respect to the housing and beam.

4. An analyzer, according to claim 3, wherein the sample site repositioner rotates the sample cup with respect to the housing and beam.

5. An analyzer, according to claim 4, wherein the sample cup is removable.

6. An analyzer, according to claim 4, wherein the sample cup's axis of rotation is not coincident with the center of an illuminated area permitting the plurality of different regions on the sample.

7. An analyzer, according to claim 1, including:
a shutter which selectively intercepts and reflects at least a part of the beam;
control circuitry further generating shutter control signals; and
a shutter motor, mechanically coupled to the shutter, receiving the shutter control signals.

8. An analyzer, according to claim 7, wherein the shutter is positioned adjacent the optical port.

9. An analyzer, according to claim 8, wherein:
the optical port includes a window; and
the shutter is positioned inside the housing adjacent the window of the optical port.

10. An analyzer, according to claim 9, further including a sample cup positioned proximate the optical port, having a base that is transmissive to the beam and the reflected beam.

11. An analyzer, according to claim 10, wherein the sample site repositioner moves the sample region with respect to the housing and beam.

12. An analyzer, according to claim 11, wherein the sample site repositioner moves the sample cup with respect to the housing and beam.

13. An analyzer, according to claim 12, wherein the sample cup is removable.

14. An analyzer, according to claim 12, wherein the sample cup's axis of rotation is not coincident with the center of an illuminated area permitting the plurality of different regions on the sample.

15. An analyzer, as in claim 7, wherein the shutter has Lambertian reflectance.

16. An analyzer, as in claim 7, wherein the shutter is comprised from a group including gold, PTFE, and aluminum.

17. An analyzer, as in claim 1, wherein the hand-held reflectance spectrometer is a MEMs-based Hadamard transform spectrometer.

18. A measurement comprising:
for a handheld reflectance spectrometer having a shutter and a sample cup with an optically transparent base,
projecting a beam onto the shutter to generate a reflected beam;
loading sample into the sample cup;
opening the shutter;
accessing a sample site of a plurality of sample sites;
measuring a reflected sample beam, including,
projecting a sample beam onto the sample to generate the reflected sample beam, and
detecting the reflected sample beam, wherein the reflected sample beam contains spectral data indicative of the sample; and
repeating the steps of accessing and measuring for each sample site of the plurality of sample sites.

19. A measurement, as in claim 18, wherein accessing a new sample site includes moving the sample cup by one of rotating the sample cup and vibrating the sample cup.

20. A measurement, as in claim 18, wherein accessing a new sample site includes one of moving the illumination beam and redirecting the detection optics to a new sample region.
